(19) United States
(12) Patent Application Publication
(10) Pub. No.: US 2024/0286484 A1
(43) Pub. Date: Aug. 29, 2024

(54) ACCELERATION DEVICE AND VEHICLE

(71) Applicants: NATIONAL UNIVERSITY CORPORATION SAITAMA UNIVERSITY, Saitama-shi, Saitama (JP); MEIWA CO., LTD., Koshigaya-shi, Saitama (JP)

(72) Inventors: Kazunori KAEDE, Saitama-shi, Saitama (JP); Kaito KOBAYASHI, Saitama-shi, Saitama (JP); Tomoya KOISHI, Saitama-shi, Saitama (JP); Yusuke MAEDA, Saitama-shi, Saitama (JP); Masanobu FUJIMORI, Koshigaya-shi, Saitama (JP); Norio ICHIBA, Koshigaya-shi, Saitama (JP); Junichi IZAWA, Koshigaya-shi, Saitama (JP)

(21) Appl. No.: 18/572,386

(22) PCT Filed: Oct. 18, 2022
(86) PCT No.: PCT/JP2022/038664

§ 371 Date: Dec. 20, 2023

(30) Foreign Application Priority Data
May 12, 2022 (JP) 2022-078945

(51) Int. Cl. B60K 26/02; G05G 5/00; G05G 5/05

(52) U.S. Cl. CPC B60K 26/02; G05G 5/005; G05G 5/05; G05G 2505/00

(57) ABSTRACT

An acceleration device can prevent abnormal acceleration of a vehicle even when an accelerator pedal is erroneously abnormally stepped on instead of a brake pedal, and alert a driver of occurrence of erroneously stepping on the accelerator pedal. Assuming that a driver erroneously steps on an accelerator pedal hard instead of a brake pedal, a magnet of a fixation part of a transmission/blocking mechanism and a magnetic opposing surface of a movable part are disengaged and separated from each other. Accordingly, movement of the accelerator pedal with respect to an accelerator lever is blocked, and the accelerator lever is returned to an idling state due to the action of the accelerator mechanism. Also, an impact and sound of the disengagement of the magnet is transmitted to the driver, and the foot takes a position different from a normal position. Accordingly, the driver can notice erroneous stepping on the accelerator pedal.

### TECHNICAL FIELD

The present invention relates to an acceleration device of a vehicle and a vehicle equipped with the acceleration device, particularly to an improvement of an erroneous operation prevention structure that reduces accidents caused by erroneously stepping on an accelerator pedal instead of a brake pedal.

### BACKGROUND ART

As a background art of preventing erroneously stepping on an accelerator pedal instead of a brake pedal, for example, there is an “Erroneous Acceleration Operation Prevention Device for Automobile” described in Patent Document 1 listed below. This device is equipped with a stopper configured to lock a lowered position of an accelerator arm at a predetermined position by axially attaching an accelerator pedal lever base part to the accelerator arm and attaching semi-fixed members that separate when a certain downward impact force is applied to a portion where the accelerator arm and the accelerator pedal lever are opposed to each other, and a buffer member is provided on the accelerator pedal lever or a floor surface, so that when the accelerator pedal is operated by a normal operation, it can be smoothly stepped on as in the conventional case, however, when the accelerator pedal is suddenly erroneously stepped on instead of a brake pedal, the movement of the accelerator pedal can be immediately stopped.

According to this, normally, as illustrated in FIGS. 1(A) and 1(B) of the same publication, when the accelerator pedal is slowly stepped on, a normal acceleration operation is performed since the accelerator pedal lever and the accelerator arm are integrated due to adsorption of permanent magnets. On the other hand, when the accelerator pedal is mistaken for the brake pedal and rapidly stepped on, as illustrated in FIGS. 3(A) to 3(D), permanent magnets separate due to an impact, and only the accelerator pedal lever is stepped on. As the foot is taken off the pedal lever, the pedal lever returns to its original state due to a spring.

### CITATION LIST

### Patent Document

Patent Document 1: Japanese Published Unexamined Patent Application No. H06-156111

### SUMMARY OF INVENTION

### Technical Problem

However, in the above-described background art, at the time of abnormally stepping-on the accelerator pedal caused by stepping on the accelerator pedal gently and then with the intention of suddenly braking by stepping on the accelerator pedal hard, as illustrated in FIGS. 4(A) to 4(D) of the same publication, the stopper comes into contact with a floor surface and supports the accelerator arm at that position, and on the other hand, only the accelerator pedal lever is further pushed down and crushes the buffer member, and the permanent magnets separate and stepping-on the accelerator arm is stopped. That is, only stepping-on the accelerator arm is stopped, and the accelerator pedal does not return. In addition, even in this state where the accelerator pedal is mistaken for the brake pedal, there is no function of alerting a driver of this, and therefore, erroneously stepping on the accelerator pedal cannot be corrected.

The present invention was made in view of these circumstances, and an object thereof is to provide an acceleration device that prevents erroneous acceleration of a vehicle even when the acceleration pedal is abnormally stepped on instead of the brake pedal, and can alert a driver of the occurrence of this caused by erroneously stepping on an accelerator pedal instead of a brake pedal.

### Solution to Problem

The present invention is characterized in that a transmission/blocking mechanism is provided between a pedal mechanism and an accelerator mechanism, and accordingly, at the time of abnormally stepping-on an accelerator pedal, the movement of the accelerator pedal with respect to the accelerator lever is blocked, and when the abnormally stepped-on state is eliminated, the mechanism returns and the movement of the accelerator pedal is transmitted to the accelerator lever.

According to a main embodiment, the blocking means uses the adsorption force of the magnets. Therefore, when abnormally stepping-on the accelerator pedal occurs, engagement due to adsorption of the magnets is released, and the movement of the accelerator pedal with respect to the accelerator lever is blocked. In addition, when blocking by the blocking means is performed, the accelerator lever is returned to a speed decelerating direction by the accelerator mechanism. When the abnormally stepped-on state is eliminated, the accelerator lever is returned by a return spring.

According to another embodiment, the accelerator pedal is provided so as to be in an extending direction of the accelerator lever at the time of idling, and in a state where blocking by the blocking means is performed, the accelerator pedal turns into a state or posture different from a normal state or posture, and accordingly, a driver can be made aware of the occurrence of erroneously stepping on an accelerator pedal instead of a brake pedal. The above-described and other objects, features, and advantages of the present invention will become clear from the following detailed description and the accompanying drawings.

### Effects of Invention

According to the present invention, when an accelerator pedal is erroneously abnormally stepped on instead of a brake pedal, the accelerator pedal and the accelerator lever are blocked, so that abnormal acceleration of a vehicle can be prevented, and a driver can be made aware of erroneously stepping on the accelerator pedal based on an impact, etc., at the time of blocking.

### BRIEF DESCRIPTION OF DRAWINGS

FIGS. 1(A) and 1(B) are views illustrating a configuration of Example 1. FIG. 1(A) illustrates a state when idling, and FIG. 1(B) illustrates an abnormally stepped-on state where the accelerator pedal is fully stepped on.

FIGS. 2(A) to 2(C) are views illustrating operation of the example. FIG. 2(A) illustrates an operation when idling, FIG. 2(B) illustrates an operation at the time of normal traveling, and FIG. 2(C) illustrates an operation at the time of abnormally stepping-on the accelerator pedal.

FIGS. 3(A) to 3(D) are views illustrating Example 2 of the present invention. FIG. 3(A) illustrates a state when idling, FIG. 3(B) illustrates a state at the time of normal traveling, FIG. 3(C) illustrates a state at the time of abnormally stepping-on the accelerator pedal, and FIG. 3(D) illustrates a state at the time of return.

FIGS. 4(A) to 4(D) are views illustrating Example 3 of the present invention. FIG. 4(A) illustrates a state when idling, FIG. 4(B) illustrates a state at the time of normal traveling, FIG. 4(C) illustrates a state at the time of abnormally stepping-on the accelerator pedal, and FIG. 4(D) illustrates a state at the time of return.

FIGS. 5(A) to 5(C) are views illustrating Example 4 of the present invention. FIG. 5(A) illustrates a state when idling, FIG. 5(B) illustrates a state at the time of normal traveling, and FIG. 5(C) illustrates a state at the time of abnormally stepping-on the accelerator pedal.

FIGS. 6(A) to 6(C) are views illustrating the above-described example from a lateral side. FIG. 6(A) illustrates a state when idling, FIG. 6(B) illustrates a state at the time of normal traveling, and FIG. 6(C) illustrates a state at the time of abnormally stepping-on the accelerator pedal.

### DESCRIPTION OF EMBODIMENT

Hereinafter, a best embodiment for carrying out the present invention will be described in detail based on examples.

### Example 1

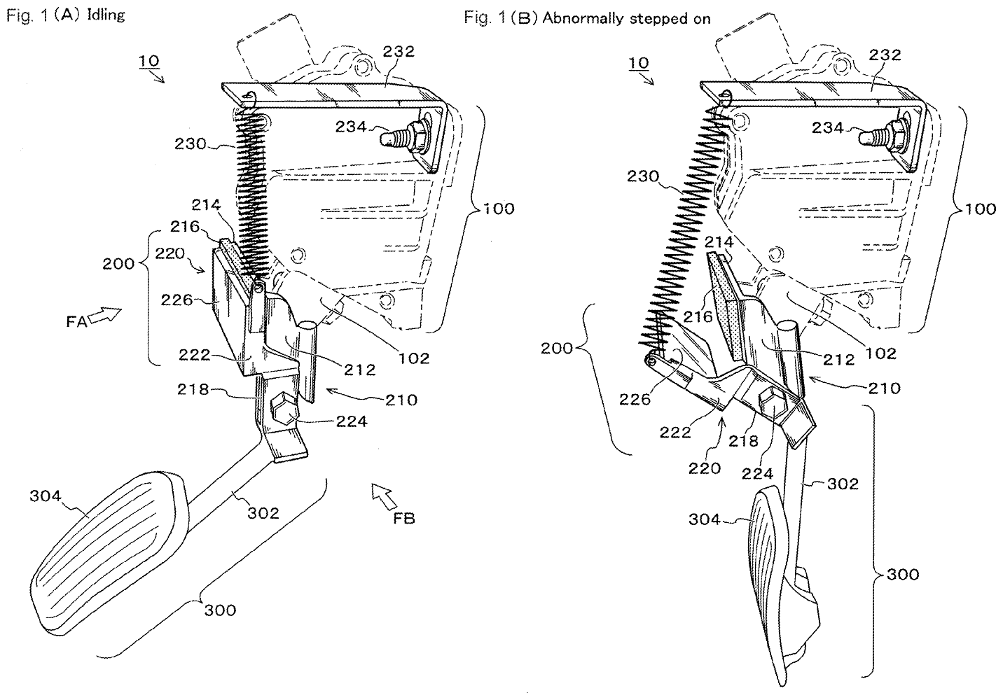

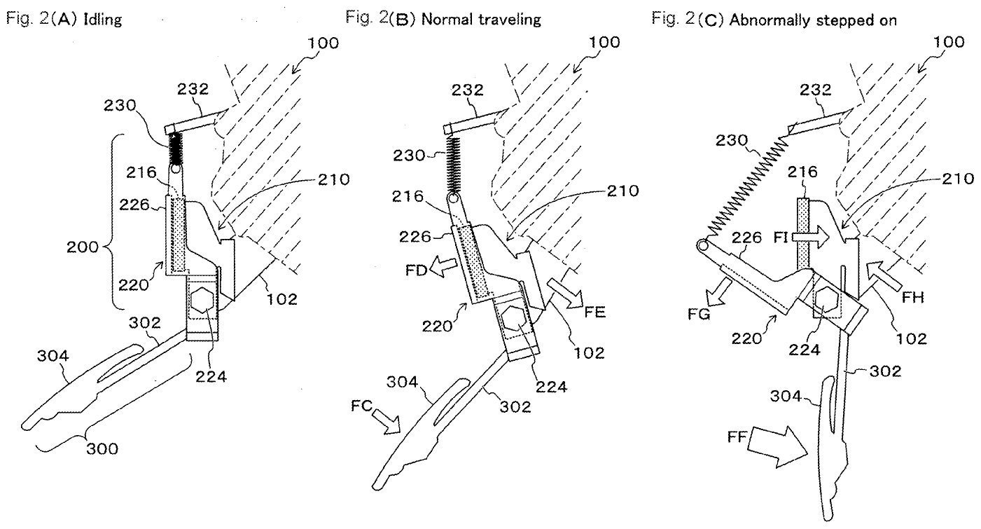

First, Example 1 of the present invention will be described with reference to FIGS. 1(A) to 1(B) and 2(A) to 2(C). FIGS. 1(A) and 1(B) illustrate the entirety of an acceleration device of the present example, FIG. 1(A) illustrates a state when idling, FIG. 1(B) illustrates an abnormally stepped-on state of the accelerator pedal. In these drawings, an acceleration device 10 is configured by being provided with an accelerator stepping-on transmission/blocking mechanism (hereinafter, simply referred to as “transmission/blocking mechanism”) 200 between an accelerator mechanism 100 and a pedal mechanism 300. The transmission/blocking mechanism 200 consists of a fixation part 210 and a movable part 220, and the fixation part 210 is provided at the accelerator mechanism 100 side and the movable part 220 is provided at the pedal mechanism 300 side.

Among these, the accelerator mechanism 100 (genuine throttle) is equipped in a general passenger vehicle, and there are various accelerator mechanisms provided. For example, the accelerator mechanism 100 has a function of detecting a stepping-on speed and a stroke of an accelerator pedal operation by sensors and converting these into electrical signals, and based on such signals, electronic throttle opening and closing control is performed. Normally, the pedal mechanism 300 is attached to a tip of an accelerator lever 102 of the accelerator mechanism 100, and the pedal mechanism is biased so as to return to an idling state by the accelerator mechanism 100 when the pedal mechanism 300 is not stepped on.

On the other hand, in the present example, a transmission/blocking mechanism 200 is provided instead of the pedal mechanism 300. Specifically, on the accelerator lever 102 of the accelerator mechanism 100, a fitting metal 212 for the fixation part 210 of the transmission/blocking mechanism 200 is provided. The shape and structure of this fitting metal 212 are adapted to the shape of the accelerator lever 102, and in the illustrated example, the fitting metal has a U shape that sandwiches the accelerator lever 102 from the outer side. This fitting metal 212 is provided with a front plate 214 at a front side viewed from the arrow FA, and on this front plate 214, a magnet 216 is provided. As the magnet 216, for example, a neodymium magnet having a strong magnetic force and adsorption force is used.

On the other hand, the fitting metal 212 is extended downward, and this extending part 218 is provided with the movable part 220. The movable part 220 mainly consists of a movable piece 222. The movable piece 222 has a substantially crank shape as viewed from a lateral side shown by the arrow FB, and is axially supported turnably around a turning shaft 224 with respect to the extending part 218. At an upper portion side of this movable piece 222, a magnetic opposing surface 226 is extended so as to be opposed to the magnet 216. This magnetic opposing surface 226 is made of a material that is magnetically engaged with the magnet 216 of the fixation part 210. To a tip end of the upper portion side of the movable piece 222, one end of a return spring 230 is fixed, and the other end of this return spring 230 is fixed to an L-shaped fixed plate 232. The fixed plate 232 is fixed to a chassis or housing side of the automobile together with the above-described accelerator mechanism 100 by a bolt-nut means 234.

On the other hand, at a lower portion side of the movable piece 222, a pedal lever 302 of the pedal mechanism 300 is provided, and at a tip end of the pedal lever 302, an accelerator pedal 304 is provided. That is, when a driver steps on the accelerator pedal 304, the movable piece 222 turns around the movable shaft 224, and the magnetic opposing surface 226 also turns against a spring force of the return spring 230. Then, as the driver eases up on or takes his/her foot off the accelerator pedal 304, the return spring 230 compresses, and accordingly, the movable piece 222 turns in the reverse direction, and the accelerator pedal 304 returns to its original position.

The pedal lever 302 and the accelerator pedal 304 of the pedal mechanism 300 are in an extending direction of the accelerator lever 102 of the accelerator mechanism 100. That is, the position of the accelerator pedal 304 is substantially the same position as in the state where the transmission/blocking mechanism 200 of the present example is not attached, and the driver can naturally perform an operation of stepping on the accelerator pedal 304.

Next, with additional reference to FIGS. 2(A) to 2(C), operation of the present example will be described. First, in an idling state where the driver does not step on the accelerator pedal 304, as illustrated in FIG. 2(A), the magnet 216 of the fixation part 210 of the transmission/blocking mechanism 200 and the magnetic opposing surface 226 of the movable part 220 are engaged with each other. In addition, the return spring 230 is in a compressed state, and the accelerator lever 102 of the accelerator mechanism 100 is at an idling position.

From this idling state, as shown by the arrow FC in FIG. 2(B), when the driver steps on the accelerator pedal 304, the movable part 220 of the transmission/blocking mechanism 200 turns in the arrow FD direction around the turning shaft 224. The magnet 216 of the fixation part 210 is engaged with the magnetic opposing surface 226 of the movable part 220, so that the fixation part 210 also turns in the arrow FD direction. Accordingly, the return spring 230 extends, and the accelerator lever 102 shifts in the arrow FE direction. Then, the throttle (not illustrated) is opened by the accelerator mechanism 100, fuel is supplied to the engine, and the engine speed increases and the automobile travels. When the accelerator pedal 304 is further stepped on, the speed increases, and when the accelerator pedal 304 is returned, the speed decreases. The automobile travels in this way.

In this traveling state, assuming that erroneously stepping on the accelerator pedal instead of the brake pedal occurs, and the driver erroneously steps on the accelerator pedal 304 hard instead of the brake pedal, as shown by the arrow FF in FIG. 2(C), the fixation part 210 and the movable part 220 of the transmission/blocking mechanism 200 separate. That is, the magnet 216 of the fixation part 210 and the magnetic opposing surface 226 of the movable part 220 are disengaged and separated from each other. Accordingly, transmission of the movement of the accelerator pedal 304 with respect to the accelerator lever 102 is blocked, and as shown by the arrow FH, the accelerator lever 102 returns to the idling state due to the action of the accelerator mechanism 100. At the same time, the fixation part 210 of the transmission/blocking mechanism 200 also reaches an idling position as shown by the arrow FI (refer to FIG. 2(A)).

That is, as the accelerator pedal 304 is abnormally stepped on, transmission of the movement with respect to the accelerator lever 102 is blocked by the transmission/blocking mechanism 200, and the engine is placed in an idling state. As the engagement by the magnet 216 is released, an impact of this release is transmitted to the driver from the foot stepping on the accelerator pedal 304. A release sound generated by the impact is also transmitted to the ears of the driver. In addition, the accelerator pedal 304 is placed in a substantially vertical state or posture at a deep side of the foot below the driver seat, and the driver's foot becomes different from that in normal times. That is, the driver's foot is significantly bent from the ankle. From these impact, sound, and foot condition accompanying the magnet release, the driver is made aware of erroneously stepping on the accelerator pedal instead of the brake pedal.

Here, when the driver takes his/her foot off the accelerator pedal 304, due to the action of the return spring 230, the accelerator pedal 304 returns to the position in the idling state, and the magnetic opposing surface 226 of the movable part 220 and the magnet 216 of the fixation part 210 are engaged with each other and return, and are placed in an idling state illustrated in FIG. 2(A). Then, as the driver steps on the brake pedal (not illustrated), the automobile stops. As the driver steps on the accelerator pedal 304, the automobile accelerates again.

As described above, according to the present example, the following effects are obtained.
a. When the accelerator pedal is erroneously abnormally stepped on instead of the brake pedal, the accelerator is released, so that the accelerator returns to a speed decelerating direction, and further, returns to an idling state. Therefore, the automobile is placed in a state where the engine brake is applied, and is decelerated.
b. When the accelerator pedal is abnormally stepped on, from an impact, sound, or foot angle caused by separation of the magnet, the driver can be made aware of erroneously stepping on the accelerator pedal instead of the brake pedal.
c. An existing accelerator mechanism can be used without change, and can be retrofitted to a passenger vehicle.

### Example 2

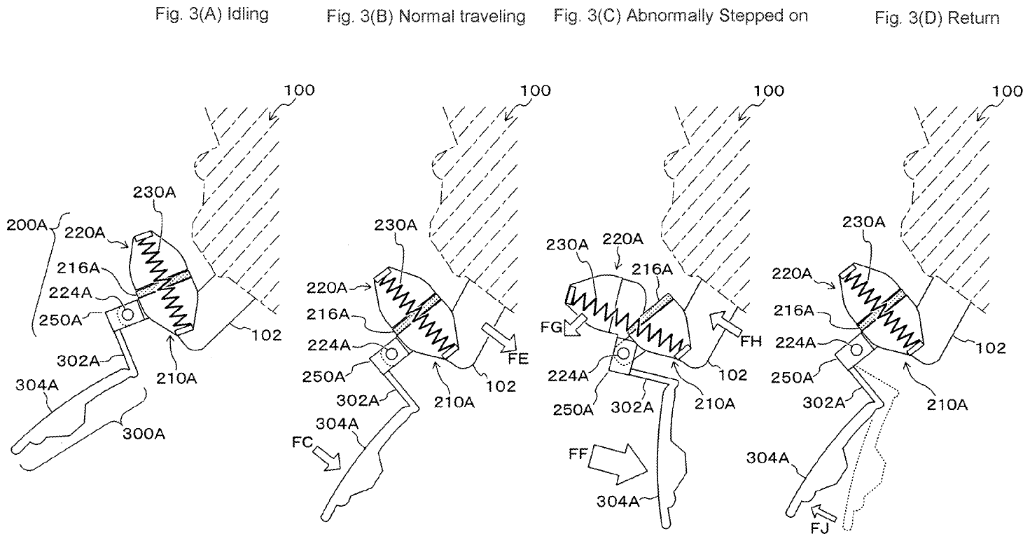

Next, Example 2 of the present invention will be described with reference to FIGS. 3(A) to 3(D). Components corresponding to those in the examples described above are provided with the same reference signs or the letter “A”. In the present embodiment, as illustrated in FIG. 3(A), the accelerator lever 102 of the accelerator mechanism 100 is provided with a transmission/blocking mechanism 200A. The transmission/blocking mechanism 200A consists of a fixation part 210A and a movable part 220A. The fixation part 210A and the movable part 220A are configured so that the movable part 220A is supported on the fixation part 210A turnably around a turning shaft 224A by a turning part 250A. To a movable part 220A side of the turning part 250A, a pedal lever 302A of a pedal mechanism 300A is attached. In the present example, the pedal lever 302A is bent with respect to the accelerator pedal 304A, and accordingly, the pedal lever 302A can be attached to the turning part 250A of the transmission/blocking mechanism 200A.

On a contact surface between the fixation part 210A and the movable part 220A, a magnet 216A is provided. The magnet 216A may be provided on a surface of either the fixation part or the movable part, and in the present example, as illustrated in FIG. 3(C), the magnet is provided on the fixation part 210A side. The return spring 230A is provided between the fixation part 210A and the movable part 220A.

Next, describing operation of the present example, in an idling state where a driver does not step on the accelerator pedal 304A, as illustrated in FIG. 3(A), the fixation part 210A and the movable part 220A of the transmission/blocking mechanism 200A are engaged with each other. From this idling state, as shown by the arrow FC in FIG. 3(B), as the driver steps on the accelerator pedal 304A, the transmission/blocking mechanism 200A entirely turns in the arrow FE direction. Accordingly, the accelerator lever 102 also shifts in the arrow FE direction. Therefore, the throttle (not illustrated) is opened by the accelerator mechanism 100, fuel is supplied to the engine, and the engine speed increases and the automobile travels. As the accelerator pedal 304A is further stepped on, the speed increases, and as the accelerator pedal 304A is returned, the speed decreases. In this way, the automobile travels.

In this traveling state, assuming that erroneously stepping on the accelerator pedal instead of the brake pedal occurs, and the driver erroneously steps on the accelerator pedal 304A hard instead of the brake pedal, as illustrated in FIG. 3(C), the fixation part 210A and the movable part 220A of the transmission/blocking mechanism 200A separate. That is, as the accelerator pedal 304 is stepped on as shown by the arrow FF, the engagement between the movable part 220A and the fixation part 210A by the magnet 216A is released, the return spring 230A extends, and the movable part 220A turns with respect to the fixation part 210A. Accordingly, even when the accelerator pedal 304A is pressed down, transmission of the movement of the accelerator pedal 304A with respect to the accelerator lever 102 is blocked, and as shown by the arrow FH, the accelerator lever 102 returns to the speed decelerating direction due to the action of the accelerator mechanism 100, and further, returns to an idling state.

In addition, as in the examples described above, an impact and sound are generated by the separation of the magnet 216A, and the accelerator pedal 304A becomes substantially vertical, so that the driver is made aware of erroneously stepping on the accelerator pedal instead of the brake pedal. Then, as the driver takes his/her foot off the accelerator pedal 304A, as illustrated in FIG. 3(D), the fixation part 210A and the movable part 220A of the transmission/blocking mechanism 200A are engaged with each other due to the action of the return spring 230A. Accordingly, the driver becomes able to perform a normal acceleration operation again.

As described above, according to the present example, even when the accelerator pedal is erroneously stepped on instead of the brake pedal, abnormal acceleration is prevented, and the driver can be made aware of erroneously stepping on the accelerator pedal instead of the brake pedal. In addition, an existing accelerator mechanism can be used without change, and can be retrofitted to a passenger vehicle.

### Example 3

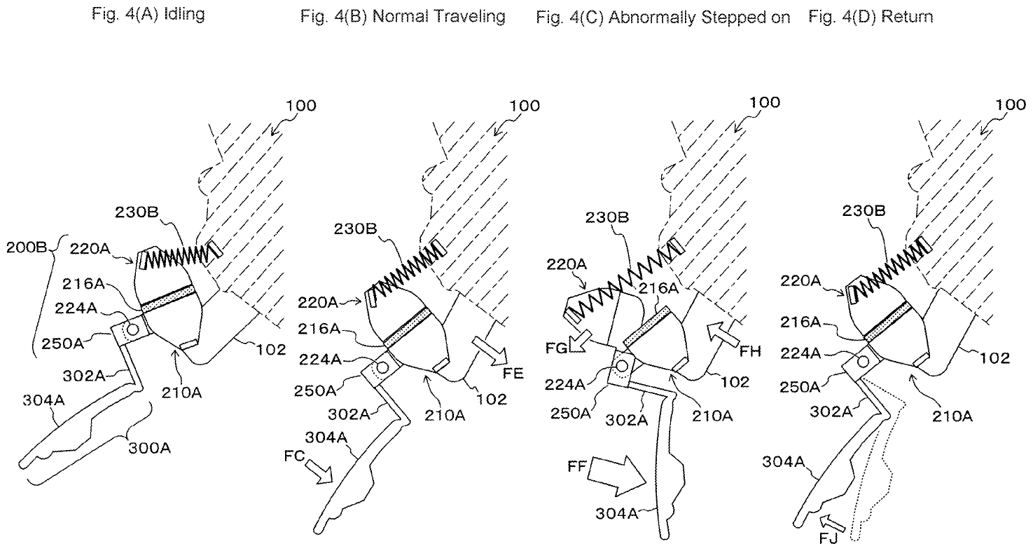

Next, Example 3 of the present invention will be described with reference to FIGS. 4(A) to 4(D). Components corresponding to those in the examples described above are provided with the same reference signs or the letter “B.” The present example is different from the example illustrated in FIGS. 3(A) to 3(D) in that a return spring 230B is provided between the accelerator mechanism 100 and the movable part 220A. Basic operations are the same as in Example 2 described above.

### Example 4

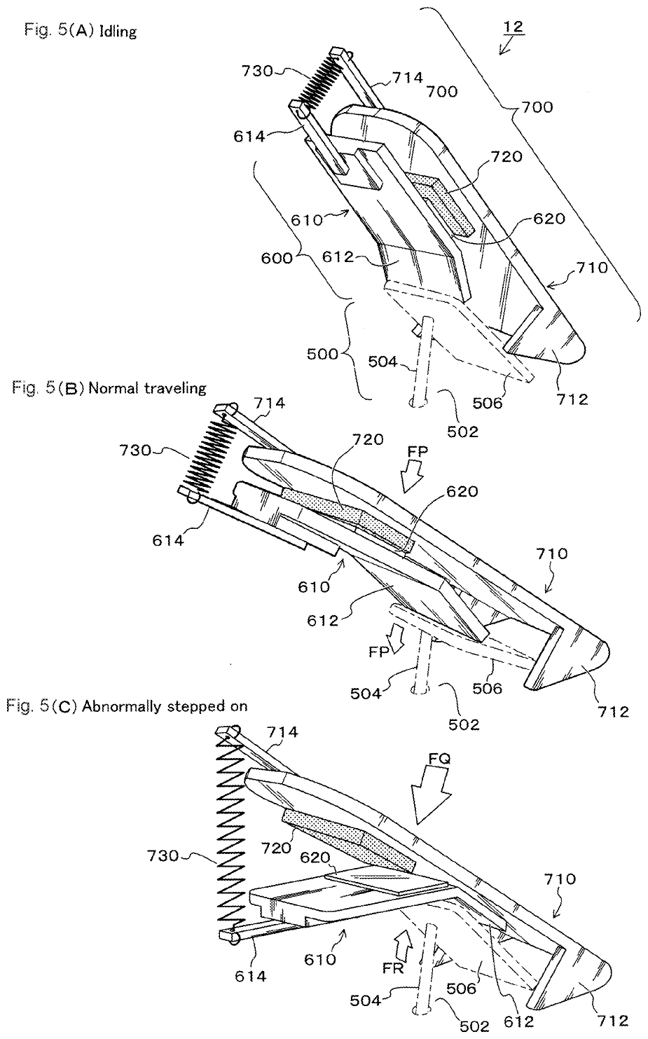

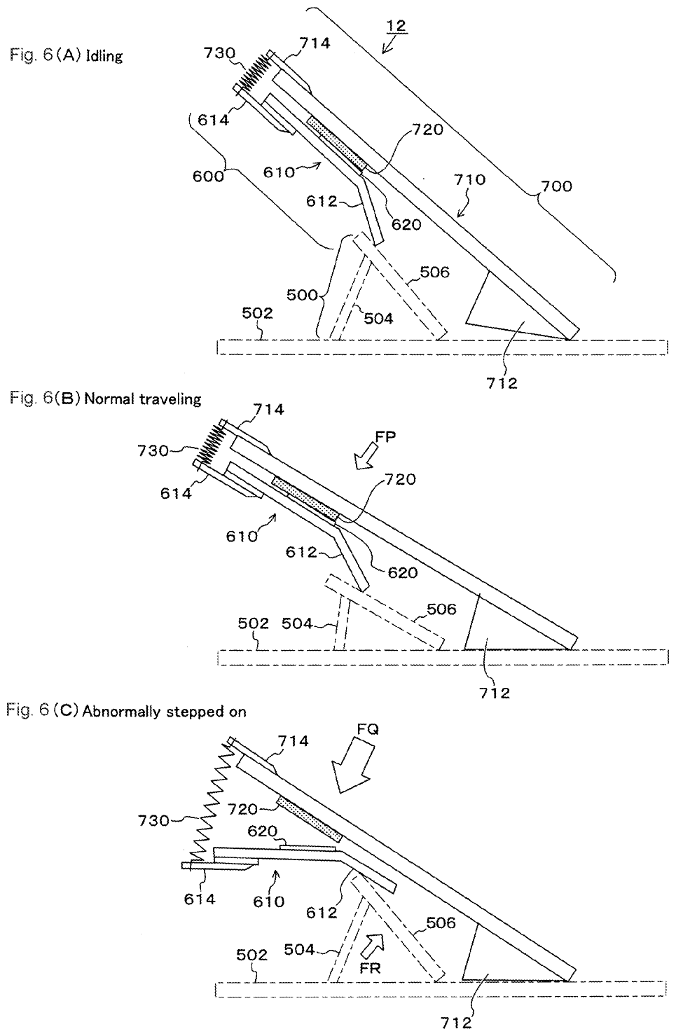

Next, Example 4 of the present invention will be described with reference to FIGS. 5(A) to 5(C) and 6(A) to 6(C). The above-described examples are the case of a suspended-type accelerator, however, the present example is an example of an organ-type accelerator including a pedal on a floor. Perspective views are illustrated in FIGS. 5(A) to 5(C), and views from a lateral side are illustrated in FIGS. 6(A) to 6(C). In these drawings, the acceleration device 12 has a configuration in which a transmission/blocking mechanism 600 is provided between an accelerator mechanism 500 and a pedal mechanism 700.

Among these, the accelerator mechanism 500 has an existing organ-type accelerator structure, and includes an accelerator lever 504 projecting from a floor surface 502 of an automobile, and a lever pedal 506 that drives this accelerator lever 504. When the accelerator lever 504 is pushed by the lever pedal 506, the throttle opens, and when the accelerator lever is released, the lever pedal 506 is returned by a spring mechanism not illustrated, and the throttle closes. These are the same as in a publicly known organ-type accelerator mechanism.

Next, the transmission/blocking mechanism 600 mainly consists of a movable piece 610. The movable piece 610 is provided along and parallel to an accelerator pedal 710 of the pedal mechanism 700, and at a lower end side, a bent part 612 bent toward the lever pedal 506 of the accelerator mechanism 500 is formed. A lower end of the bent portion 612 side is in contact with the lever pedal 506 of the accelerator mechanism 500. At an upper end side of the movable piece 610, an arm 614 is extended.

On the other hand, the pedal mechanism 700 mainly consists of the accelerator pedal 710, and a lower end of the accelerator pedal is in contact with the floor surface 502. On both side surfaces of the lower end of the accelerator pedal 710, triangular regulating plates 712 that regulate downward movement of the accelerator pedal are respectively provided. At an upper end side of the accelerator pedal 710, an arm 714 is extended. A return spring 730 is provided between the arm 714 and the arm 614 on the movable piece 610 side of the above-described transmission/blocking mechanism 600. Further, on a back surface of the above pedal 710, a magnet 720 is provided on a surface facing the movable piece 610, and on the movable piece 610 side, a magnetic opposing surface 620 is provided.

Next, describing operation of the present example, in an idling state where a driver does not step on the accelerator pedal 710, as illustrated in FIGS. 5(A) and 6(A), the magnetic opposing surface 620 of the movable piece 610 and the magnet 720 of the accelerator pedal 710 are engaged with each other, and the return spring 730 is compressed, and the movement of the accelerator pedal 710 is transmitted to the lever pedal 506 through the transmission/blocking mechanism 600.

From this idling state, as shown by the arrow FP in FIGS. 5(B) and 6(B), when a driver steps on the accelerator pedal 710, the lower end of the movable piece 610 of the transmission/blocking mechanism 600 pushes the lever pedal 506 of the accelerator mechanism 500, the throttle (not illustrated) is opened by the accelerator mechanism 500, fuel is supplied to the engine, and the engine speed increases and the automobile travels. As the accelerator pedal 710 is further stepped on, the speed increases, and as the accelerator pedal 710 is returned, the speed decreases.

In such a traveling state, assuming that erroneously stepping on the accelerator pedal instead of the brake pedal occurs and the driver steps on the accelerator pedal 710 hard instead of the brake pedal, as shown by the arrow FQ in FIGS. 5(C) and 6(C), the magnet 720 on the accelerator pedal 710 side and the magnetic opposing surface 620 on the movable piece 610 side separate from each other, and transmission of the movement of the accelerator pedal 710 with respect to the accelerator lever 520 is blocked, and as shown by the arrow FR, the accelerator lever 504 returns to an idling state due to the action of the accelerator mechanism 500.

That is, when the accelerator pedal 710 is abnormally stepped on, transmission of the movement with respect to the accelerator lever 504 is blocked by the transmission/blocking mechanism 600, and the engine is placed in an idling state. When the engagement by the magnet 720 is released, an impact of the release is transmitted to the driver from the foot stepping on the accelerator pedal 710. In addition, a release sound generated at the time of the impact is also transmitted to the ears of the driver. From these impact and sound accompanying the magnet release, the driver is made aware that he/she has stepped on the accelerator pedal instead of the brake pedal.

Here, when the driver takes his/her foot off the accelerator pedal 710, the movable piece 610 returns to the position of the idling state due to the action of the return spring 730, the magnetic opposing surface 620 of the movable piece 610 and the magnet 720 are engaged with each other and return, and accordingly, the mechanism is placed in the idling state illustrated in FIGS. 5(A) and 6(A). Then, as the driver steps on the brake pedal (not illustrated), the automobile stops. As the driver steps on the accelerator pedal 710, the automobile accelerates again. This example also brings about the same technical effects as in the examples described above.

### Other Examples

The present invention is not limited to the examples described above, and can be variously modified without departing from the scope of the present invention. For example, the following are also included.
(1) The shapes and dimensions of the respective parts shown in the examples described above are just examples, and can be modified so as to bring about the same operations.
(2) The strength of the adsorption force of the magnet shown in the examples is set as appropriate depending on how strong stepping-on the accelerator pedal judged as an abnormality is. The strength of the adsorption force may be set for each driver.
(3) The present invention is mainly applied to automobiles, but is applicable to all vehicles that accelerate and decelerate by a method using an accelerator pedal.

### INDUSTRIAL APPLICABILITY

According to the present invention, when the accelerator pedal is erroneously abnormally stepped on instead of the brake pedal, the accelerator pedal and the accelerator lever are blocked, so that the vehicle can be prevented from accelerating, and a driver can be made aware of erroneously stepping on the accelerator pedal based on an impact, etc., generated at the time of the blocking, and therefore, the present invention is preferable as an acceleration device of a vehicle which reduces accidents caused by erroneously stepping on the accelerator pedal instead of the brake pedal.

### REFERENCE SIGNS LIST

10, 12: Acceleration device
100: Accelerator mechanism
102: Accelerator lever
200, 200A: Transmission/blocking mechanism
210, 210A: Fixation part
212: Fitting metal
214: Front plate
216, 216A: Magnet
218: Extending part
220, 220A: Movable part
222: Movable piece
224, 224A: Turning shaft
226: Magnetic opposing surface
230, 230A, 230B: Return spring
232: Fixed plate
234: Bolt-nut means
250A: Turning part
300, 300A: Pedal mechanism
302, 302A: Pedal lever
304, 304A: Accelerator pedal
500: Accelerator mechanism
502: Floor surface
504: Accelerator lever
506: Lever pedal
600: Transmission/blocking mechanism
610: Movable piece
612: Bent part
614: Arm
620: Magnetic opposing surface
700: Pedal mechanism
710: Accelerator pedal
712: Regulating plate
714: Arm
720: Magnet
730: Return spring

1-11. (canceled)

12. An acceleration device as an acceleration device of a vehicle which transmits movement of an accelerator pedal in a pedal mechanism provided on a floor of a vehicle to an accelerator lever of an accelerator mechanism, the acceleration device comprising:
a transmission/blocking mechanism provided between the pedal mechanism and the accelerator mechanism, wherein
the transmission/blocking mechanism comprising:
a movable piece provided between the pedal mechanism and the accelerator mechanism;
an blocking means provided between the movable piece and the accelerator pedal, and configured to block movement of the accelerator pedal with respect to the accelerator lever when the accelerator pedal is abnormally stepped on; and
a return means configured to, when an abnormally stepped-on state is eliminated, return the blocking means and transmit the movement of the accelerator pedal to the accelerator lever,
the accelerator mechanism comprises a lever pedal configured to transmit movement of the accelerator pedal to the accelerator lever,
the movable piece is provided along and parallel to the accelerator pedal of the pedal mechanism, and comprises, at a lower end side, a bent part bent toward the lever pedal, and
a lower end of the bent part is in contact with the lever pedal.

13. An acceleration device as an acceleration device of a vehicle which transmits movement of an accelerator pedal in a pedal mechanism to an accelerator lever of an accelerator mechanism already provided in a vehicle, the acceleration device comprising:
a transmission/blocking mechanism provided between the accelerator pedal of the pedal mechanism and the accelerator lever of the accelerator mechanism, wherein
the transmission/blocking mechanism comprising:
a fixation part attached to the accelerator lever;
a movable part attached to the accelerator pedal;
an blocking means provided between the fixation part and the movable part, and configured to block movement of the accelerator pedal with respect to the accelerator lever when the accelerator pedal is abnormally stepped on; and
a return means configured to, when an abnormally stepped-on state is eliminated, return the blocking means and transmit the movement of the accelerator pedal to the accelerator lever.

14. The acceleration device according to claim 13, wherein the return means consists of a return spring provided between the movable part and a housing of a vehicle, between the movable part and the accelerator mechanism, or between the movable part and the fixation part.

15. The acceleration device according to claim 13, wherein the accelerator pedal is provided so as to be in an extending direction of the accelerator lever at the time of idling.

16. The acceleration device according to claim 12, wherein the accelerator pedal is provided to have a structure that becomes different from a normal state in a state where blocking by the blocking means is performed.

17. The acceleration device according to claim 12, wherein the return means consists of a return spring provided between the movable piece and the accelerator pedal.

18. The acceleration device according to claim 12, wherein, when blocking by the blocking means is performed, the accelerator lever is returned to a speed decelerating direction by the accelerator mechanism.

19. The acceleration device according to claim 12, wherein the blocking means uses an adsorption force of a magnet.

20. A vehicle equipped with the acceleration device according to claim 12.

21. The acceleration device according to claim 13, wherein, when blocking by the blocking means is performed, the accelerator lever is returned to a speed decelerating direction by the accelerator mechanism.

22. The acceleration device according to claim 13, wherein the blocking means uses an adsorption force of a magnet.

23. A vehicle equipped with the acceleration device according to claim 13.
